(19) United States
(12) Patent Application Publication
(10) Pub. No.: US 2011/0141199 A1
(43) Pub. Date: Jun. 16, 2011

(54) Inkjet head assembly

(75) Inventors: Jae Hun Kim, Seoul (KR); Jae Woo Joung, Suwon (KR); Young Seuck Yoo, Seoul (KR); Yoon Sok Park, Suwon (KR)

(73) Assignee: SAMSUNG ELECTRO-MECHANICS CO., LTD., Suwon (KR)

(21) Appl. No.: 12/801,923

(22) Filed: Jul. 1, 2010

(30) Foreign Application Priority Data
Dec. 14, 2009 (KR) 10-2009-0124121

(51) Int. Cl. B41J 2/045

(52) U.S. Cl. 347/68

(57) ABSTRACT

An inkjet head assembly includes: a tank head having an ink channel formed therein; an inkjet head disposed in the tank head to jet ink introduced through the ink channel; and a mass disposed on the inkjet head and applying a weight to control vibrations when ink is jetted from the inkjet head.

### CROSS-REFERENCE TO RELATED APPLICATIONS

This application claims the priority of Korean Patent Application No. 10-2009-0124121 filed on Dec. 14, 2009, in the Korean Intellectual Property Office, the disclosure of which is incorporated herein by reference.

### BACKGROUND OF THE INVENTION

1. Field of the Invention

The present invention relates to an inkjet head assembly, and more particularly, to an inkjet head assembly capable of securing behavior stability in ink droplets and performing printing of a uniform quality.

2. Description of the Related Art

In general, an inkjet head refers to a device which jets minute droplets of printing ink onto a desired position of a print sheet to print a predetermined color of an image. The inkjet head has recently been used in an industrial inkjet printer.

The inkjet head directly forms a circuit pattern by spraying ink containing metals such as gold and silver onto a printed circuit board (PCB). The inkjet head is used for manufacturing industrial graphics, liquid crystal displays (LCD), organic light emitting diodes (OLED), solar cells, and the like.

The inkjet head may be divided into two types, depending on an ink jetting method. One type is a thermally-driven inkjet head which uses a heat source to generate bubbles in ink and then jets the ink using an expansion force of the bubbles, and the other type is a piezoelectric inkjet head which jets ink using a pressure applied to the ink by the deformation of a piezoelectric body.

The piezoelectric inkjet head includes an inlet and outlet for introducing and discharging ink into and from a cartridge, a manifold for storing the introduced ink, a pressure chamber for transferring the ink inside the manifold to a nozzle, and a piezoelectric actuator mounted on the piezoelectric chamber to jet ink to the outside.

The droplets jetted from the piezoelectric inkjet head have a very small size. Therefore, a printing quality may be degraded by a minute vibration.

### SUMMARY OF THE INVENTION

An aspect of the present invention provides an inkjet head assembly capable of securing behavior stability in ink droplets and performing printing of a uniform quality.

According to another aspect of the present invention, there is provided an inkjet head assembly including: a tank head having an ink channel formed therein; an inkjet head disposed in the tank head to jet ink introduced through the ink channel; and a mass disposed on the inkjet head and applying a weight to control vibrations when ink is jetted from the inkjet head.

A mass ratio of the mass to the inkjet head may range from 0.1 to 100.

The mass may include a plurality of unit masses.

The mass may be formed in a sheet shape.

The mass may include a plurality of ring-shaped unit masses having a through hole formed therein.

The mass may include a plurality of unit masses having the same mass.

The mass may include a plurality of unit masses having the same mass and disposed at constant intervals.

The inkjet head assembly may further include a piezoelectric actuator mounted thereon and a flexible printed circuit for applying an actuating voltage to the piezoelectric actuator.

The mass may be disposed to apply a weight to the flexible printed circuit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a schematic perspective view of an inkjet head assembly according to an embodiment of the present invention;

FIG. 1B is a schematic cross-sectional view of the inkjet head assembly, taken along a line A-A′ of FIG. 1A;

FIG. 2 is a schematic perspective view of an inkjet package in which the inkjet head assembly according to the embodiment of the present invention is connected to an ink tank;

FIG. 3A is a schematic perspective view of an inkjet head 20 according to the embodiment of the present invention;

FIG. 3B is a schematic cross-sectional view of the inkjet head 20, taken along a line B-B′ of FIG. 3A; and

FIG. 4 is a schematic perspective view of an inkjet head assembly according to another embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and a description thereof will be omitted.

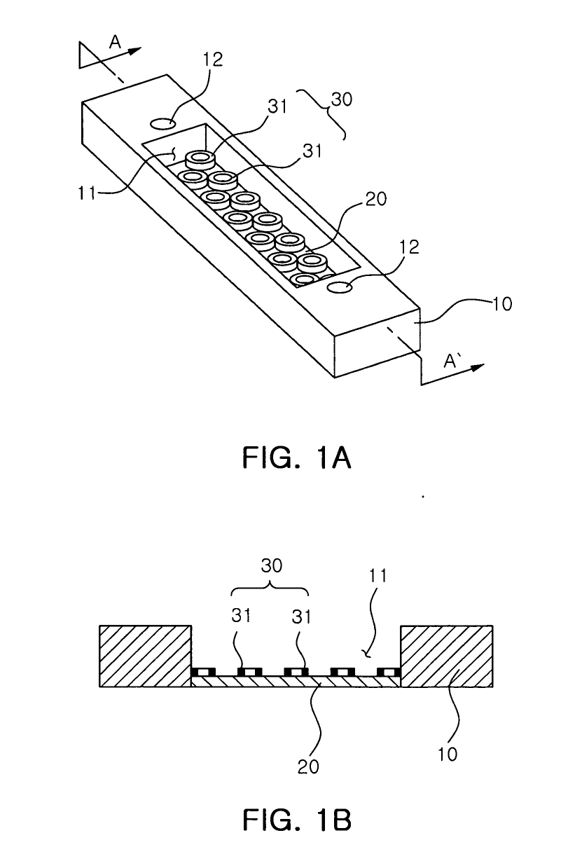

FIG. 1A is a schematic perspective view of an inkjet head assembly according to an embodiment of the present invention. FIG. 1B is a schematic cross-sectional view of the inkjet head assembly, taken along a line A-A′ of FIG. 1A.

Referring to FIGS. 1A and 1B, the inkjet head assembly according to the embodiment of the present invention includes a tank head 10, an inkjet head 20 disposed in the tank head, and a mass 30 disposed on the inkjet head.

The tank head 10 includes an ink channel 11 through which ink flows to be supplied to the inkjet head 20 disposed in the tank head 10.

The tank head 10 may be connected to a unit to supply ink to the ink channel 11.

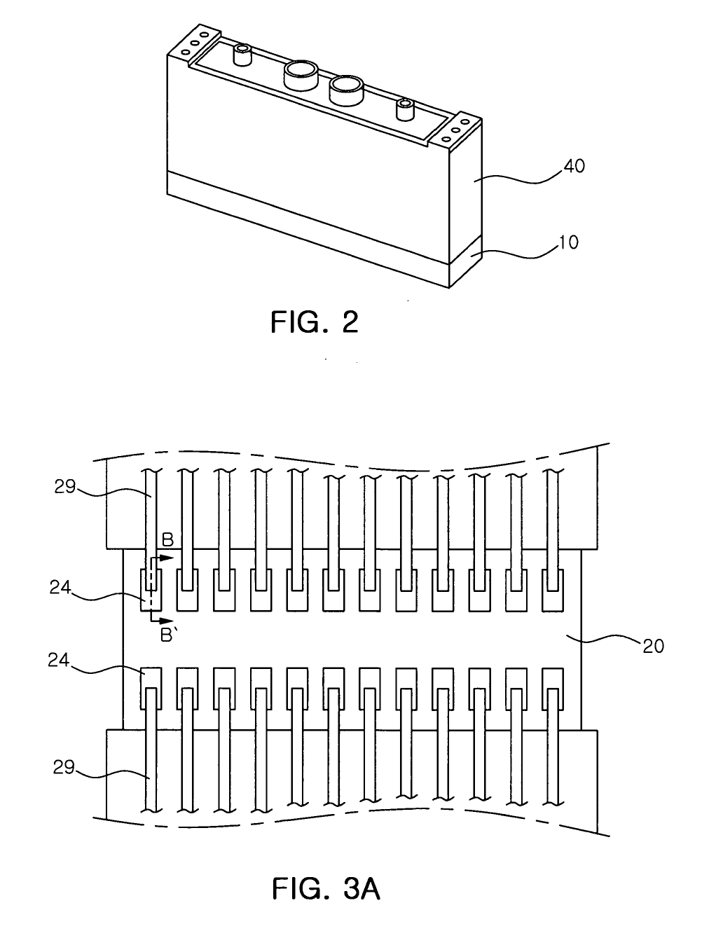

FIG. 2 is a schematic perspective view of an inkjet package in which the inkjet head assembly according to the embodiment of the present invention is connected to an ink tank.

Referring to FIG. 2, an ink tank 40 is mounted on the tank head 10. The tank head 10 includes an ink flow path 12 through which ink is supplied from the ink tank 40.

The ink flow path 12 communicates with the ink channel 11 to supply ink to the ink channel 11.

The method for supplying ink to the ink channel 11 inside the tank head 10 is not limited to the above-described method.

The inkjet head 20 disposed in the tank head 10 serves to jet ink introduced through the ink channel 11 of the tank head 10.

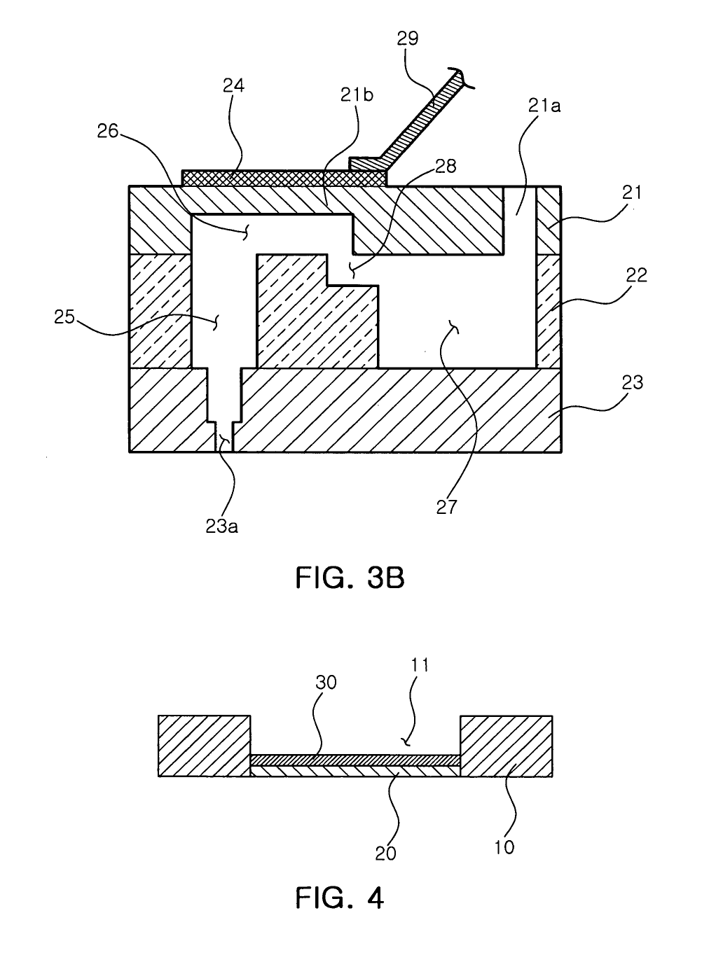

FIG. 3A is a schematic perspective view of the inkjet head 20 according to the embodiment of the present invention. FIG. 3B is a schematic cross-sectional view of the inkjet head 20, taken along a line B-B′ of FIG. 3A.

Referring to FIGS. 3A an 3B, the inkjet head 20 according to the embodiment of the present invention includes a flow path plate 21, an intermediate plate 22, a nozzle plate 23, and a piezoelectric actuator 24.

The flow path plate 21 includes a plurality of ink chambers 26 formed in a regular manner and an ink inlet 21a for introducing ink. The ink inlet 21a is directly connected to a manifold 27 which serves to supply ink to the ink chambers 26 through a restrictor 28.

At this time, the manifold 27 may be formed with a large space connected to the plurality of ink chambers 26. Without being limited thereto, however, a plurality of manifolds may be formed to correspond to the respective ink chambers 26.

As described above, only one ink inlet 21a may be formed to correspond to one manifold 27. However, a plurality of ink inlets 21a may be formed.

The ink chamber 26 is provided under a position at which the piezoelectric actuator 24 to be described below is mounted. In this case, a portion of the flow path plate 21, forming the ceiling of the ink chamber 26, serves as a vibration plate 21b.

Therefore, when an actuating signal is applied to the piezoelectric actuator 24 to jet ink, the vibration plate 21b under the piezoelectric actuator 24 is deformed with the piezoelectric actuator 24, and the volume of the ink chamber 26 decreases.

Accordingly, as the internal pressure of the ink chamber 26 increases, the ink inside the ink chamber 26 is jetted to the outside through a damper 25 and a nozzle 23a.

The spaces of the flow path plate 21 may be formed by one etching process to form the ink chamber 26 and the ink inlet 21a.

The intermediate plate 22 may include the manifold formed in the longitudinal direction thereof and the damper 25 connecting the nozzle 23a and the ink chamber 26.

The manifold 27 receives ink from the ink inlet 21a to supply to the ink chamber 26. The manifold 27 and the ink chamber 26 are connected to each other by the restrictor 28.

The damper 25 receives the ink jetted from the ink chamber 26 by the piezoelectric actuator 24, and then jets the received ink to the outside through the nozzle 23a.

The damper 25 may be formed with a multi-step structure by which the amount of ink to be received from the ink chamber 60 and the amount of ink to be transferred to the nozzle 35 are adjusted.

The damper 25 is an optional component which may be omitted. In this case, the inkjet head 20 may be constructed with only the flow path plate 21 and the nozzle plate 23 which will be described below.

The nozzle plate 23 is formed to correspond to the respective ink chambers 26 and includes a nozzle 23a for jetting the ink passing through the damper 25. The nozzle plate 23 is attached under the intermediate plate 22.

The nozzle 23a jets ink moving through the flow path formed in the inkjet head 20 as droplets.

At this time, a silicon substrate which is widely used in a semiconductor IC may be used as the flow path plate 21, the intermediate plate 22, and the nozzle plate 23.

The piezoelectric actuator 24 may include a lower electrode, a piezoelectric body, and an upper electrode which are sequentially stacked on the flow path plate 21. The piezoelectric body may be formed of a lead zirconate titanate (PZT) ceramic material which is a piezoelectric material.

The upper electrode serves as an actuating electrode which applies a voltage to the piezoelectric body, and is connected to a flexible printed circuit board (FPCB) 29 for applying a voltage. Furthermore, the upper electrode is electrically connected to an actuating unit through the FPCB 29.

When the upper electrode applies an actuating pulse, the piezoelectric body is deformed to deform the vibration plate 21b such that the volume of the ink chamber 26 is changed. Then, the ink inside the ink chamber 26 is jetted through the nozzle 23a.

After being completely manufactured, the inkjet head 20 is disposed in the tank head 10. The ink flowing in the ink channel 11 is introduced into the inkjet head through the inlet 21a and jetted through the nozzle 23a.

The mass 30 disposed on the inkjet head serves to apply weight to control vibrations when ink is jetted from the inkjet head.

The inkjet head 20 is disposed in the tank head 10 through a joining material. In this case, when a joining material with a high degree of hardness is used, the inkjet head may be destroyed by stress caused by processing during the actuation of the piezoelectric actuator 24. Therefore, a soft joining material with a low degree of hardness is used to couple the inkjet head 20 to the tank head 10.

However, when the soft joining material with a low degree of hardness is used, a displacement occurs in the inkjet head during the actuation of the piezoelectric actuator.

The displacement of the inkjet head may have an effect upon a waveform change of ink occurring when the ink is jetted and jetting performance.

According to this embodiment, however, the mass is placed on the inkjet head to control the displacement of the inkjet head. Accordingly, the number of external factors having an effect during the ink jetting may be reduced to secure behavior stability in ink droplets jetted therefrom, and printing of a uniform quality may be performed.

A mass ratio of the mass 30 to the inkjet head 20 may range from 0.1 to 100, but is not limited thereto. Desirably, the mass ratio may range from 1 to 50. More desirably, the mass ratio may range from 1 to 7.

The mass 30 may include a plurality of unit masses 30 which are formed in a ring shape having a through hole formed therein.

The plurality of unit masses 31 may be disposed at predetermined intervals on the inkjet head. Furthermore, the plurality of unit masses 31 may have the same mass.

When the mass 30 is composed of the plurality of unit masses 31 and a space is provided between the respective unit masses, an area capable of absorbing the vibration of the inkjet head may be extended to secure behavior stability in droplets.

The mass 30 may be disposed on the FPCB connected to the piezoelectric actuator of the inkjet head to apply a weight to the FPCB. Accordingly, it is possible to prevent the vibration of the inkjet head caused by the FPCB.

A binder may be formed on the inkjet head, and the mass 30 may be fixed by the binder. The binder is not limited specifically, as long as it has an adhesive force. A material with a hardness of 100 A or less may be used. For example, polydimethylsiloxane (PDMS) may be used.

FIG. 4 is a schematic perspective view of an inkjet head assembly according to another embodiment of the present invention. The following description will be focused on different components from those of the inkjet head assembly according to the above-described embodiment of the present invention, and the detailed description of the same components will be omitted.

Referring to FIG. 4, the inkjet head assembly according to this embodiment of the present invention includes a tank head 10 having an ink channel 11 formed therein, an inkjet head 20 disposed in the tank head to jet ink introduced through the ink channel, and a mass 30 disposed on the inkjet head to apply a weight to control vibrations when ink is jetted from the inkjet head.

The mass 30 may be formed in a sheet shape. One sheet-shaped mass may be disposed to cover the entire inkjet head. The mass may include a plurality of sheet-shaped unit masses which are disposed at predetermined intervals on the inkjet head.

According to the embodiment of the present invention, when the inkjet head is coupled to the tank head to jet ink, a displacement is prevented from occurring in the inkjet head.

The displacement of the inkjet head may have an effect upon a waveform change of ink occurring when ink is jetted and jetting performance. According to the embodiment of the present invention, however, the mass is placed on the inkjet head to control the displacement of the inkjet head. Accordingly, the number of external factors having an effect during the ink jetting may be reduced to secure behavior stability in ink droplets, and printing of a uniform quality may be performed.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head assembly comprising:
a tank head having an ink channel formed therein;
an inkjet head disposed in the tank head to jet ink introduced through the ink channel; and
a mass disposed on the inkjet head and applying a weight to control vibrations when ink is jetted from the inkjet head.

2. The inkjet head assembly according to claim 1, wherein a mass ratio of the mass to the inkjet head ranges from 0.1 to 100.

3. The inkjet head assembly according to claim 1, wherein the mass comprises a plurality of unit masses.

4. The inkjet head assembly according to claim 1, wherein the mass is formed in a sheet shape.

5. The inkjet head assembly according to claim 1, wherein the mass comprises a plurality of ring-shaped unit masses having a through hole formed therein.

6. The inkjet head assembly according to claim 1, wherein the mass comprises a plurality of unit masses having the same mass.

7. The inkjet head assembly according to claim 1, wherein the mass comprises a plurality of unit masses having the same mass and disposed at constant intervals.

8. The inkjet head assembly according to claim 1, further comprising a binder formed on the inkjet head to fix the mass.

9. The inkjet head assembly according to claim 1, wherein the inkjet head comprises a piezoelectric actuator mounted thereon and a flexible printed circuit for applying an actuating voltage to the piezoelectric actuator.

10. The inkjet head assembly according to claim 9, wherein the mass is disposed to apply a weight to the flexible printed circuit.
